(19) United States
(12) Patent Application Publication
(10) Pub. No.: US 2024/0022170 A1
(43) Pub. Date: Jan. 18, 2024

(54) HIGH-FREQUENCY SWITCHING DC/DC CONVERTER WITH DIFFERENT CONTROL LOOP AND SWITCHING FREQUENCIES

(71) Applicant: Lumentum Operations LLC, San Jose, CA (US)

(72) Inventors: Nathaniel BLACK, San Jose, CA (US); Xiuge CHE, San Jose, CA (US)

(21) Appl. No.: 17/936,600

(22) Filed: Sep. 29, 2022

Related U.S. Application Data
(60) Provisional application No. 63/368,452, filed on Jul. 14, 2022.

(51) Int. Cl. H02M 3/158; H02M 1/00

(52) U.S. Cl. CPC H02M 3/158; H02M 1/0003

(57) ABSTRACT

In some implementations, a microcontroller may trigger a control loop to read a feedback voltage based on an interrupt that has a periodicity based on a control loop frequency. The microcontroller may calculate a target duty cycle for a first transistor and a second transistor based on the feedback voltage. The target duty cycle may control respective proportions of time that the first transistor and the second transistor spend in an on state. The microcontroller may output, based on the target duty cycle, a first pulse-width modulation (PWM) signal to switch a state of the first transistor and a second PWM signal to switch a state of the second transistor. In some implementations, the first PWM signal and the second PWM signal may be associated with a switching frequency that differs from the control loop frequency.

### CROSS-REFERENCE TO RELATED APPLICATION

This Patent Application claims priority to U.S. Provisional Patent Application No. 63/368,452, filed on Jul. 14, 2022, and entitled “HIGH-FREQUENCY SWITCHING DC-DC CONVERTER WITH DIFFERENT FREQUENCIES FOR CONTROL LOOP AND MOSFET.”The disclosure of the prior Application is considered part of and is incorporated by reference into this Patent Application.

### TECHNICAL FIELD

The present disclosure relates generally to a power converter and to a switching direct current/direct current (DC/DC) converter.

### BACKGROUND

A power converter is an electrical or electro-mechanical device that can convert electrical energy from one form to another. For example, a power converter may be designed to convert alternating current (AC) into direct current (DC), convert DC into AC, change a voltage or a frequency associated with a current, and/or any suitable combination thereof. In general, an electronic circuit or electromechanical device that converts DC from a first voltage level to a second voltage level is generally referred to as a DC/DC converter, a DC-to-DC converter, or the like. Power levels that may be handled in a DC/DC converter may range from very low (e.g., small batteries) to very high (e.g., high-voltage power supply).

### SUMMARY

In some implementations, a switching DC/DC converter includes a first transistor arranged to receive an input voltage; a second transistor, wherein the second transistor is in an off state when the first transistor is in an on state and the second transistor is in the on state when the first transistor is in the off state; an energy storage device configured to store energy when the first transistor is in the on state and to discharge the stored energy when the second transistor is in the on state; a load driven by an output current produced by the input voltage when the first transistor is in the on state and by the stored energy discharged from the energy storage device when the second transistor is in the on state; a feedback circuit arranged to convert the output current into a feedback voltage; and a microcontroller configured to: trigger a control loop to read the feedback voltage based on an interrupt, wherein the interrupt has a periodicity that is based on a control loop frequency; calculate a target duty cycle for the first transistor and the second transistor based on the feedback voltage, wherein the target duty cycle controls respective proportions of time that the first transistor and the second transistor spend in the on state; and output, based on the target duty cycle, a first pulse-width modulation (PWM) signal to switch the first transistor between the on state and the off state and a second PWM signal to switch the second transistor between the on state and the off state, wherein the first PWM signal and the second PWM signal are associated with a switching frequency that differs from the control loop frequency.

In some implementations, a method for operating a DC/DC converter includes generating, based on an input voltage provided to a first transistor, an output current to drive a load when the first transistor is in an on state, wherein a storage device stores energy when the first transistor is in the on state; generating, based on the energy stored by the storage device, the output current to drive the load when a second transistor is in the on state, wherein the second transistor is in an off state when the first transistor is in the on state and the second transistor is in the on state when the first transistor is in the off state; triggering, by a microcontroller, a control loop to read a feedback voltage based on the output current based on an interrupt that has a periodicity based on a control loop frequency; calculating, by the microcontroller, a target duty cycle for the first transistor and the second transistor based on the feedback voltage; and output, by the microcontroller based on the target duty cycle, a first PWM signal to switch the first transistor between the on state and the off state and a second PWM signal to switch the second transistor between the on state and the off state, wherein the first PWM signal and the second PWM signal are associated with a switching frequency that differs from the control loop frequency.

In some implementations, a method for controlling a DC/DC converter includes triggering, by a microcontroller, a control loop to read a feedback voltage based on an interrupt, wherein the interrupt has a periodicity that is based on a control loop frequency; calculating, by the microcontroller, a target duty cycle for a first transistor and a second transistor based on the feedback voltage, wherein the target duty cycle controls respective proportions of time that the first transistor and the second transistor spend in an on state; and outputting, by the microcontroller and based on the target duty cycle, a first PWM signal to switch the first transistor between the on state and an off state and a second PWM signal to switch the second transistor between the on state and the off state, wherein the first PWM signal and the second PWM signal are associated with a switching frequency that differs from the control loop frequency.

### BRIEF DESCRIPTION OF THE DRAWINGS

FIG. 1 is a diagram of an example direct current/direct current (DC/DC) converter.

FIG. 2 is a diagram of an example high-frequency switching DC/DC converter with different control loop and switching frequencies described herein.

FIG. 3 is a flowchart of an example process associated with operating a control loop in the high-frequency switching DC/DC converter described herein.

FIG. 4 is a diagram of example waveforms in a DC/DC converter that uses a single control loop and switching frequency relative to example waveforms in the high-frequency switching DC/DC converter described herein.

FIG. 5 is a diagram of example components of a device associated with a high-frequency switching DC/DC converter with different control loop and switching frequencies.

FIG. 6 is a flowchart of an example process associated with controlling a high-frequency switching DC/DC converter with different control loop and switching frequencies.

### DETAILED DESCRIPTION

The following detailed description of example implementations refers to the accompanying drawings. The same reference numbers in different drawings may identify the same or similar elements.

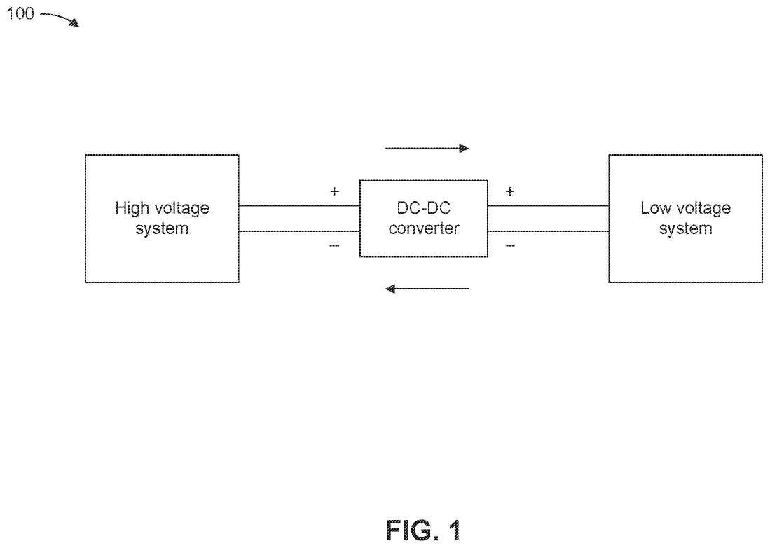

FIG. 1 illustrates an example 100 of an electrical system or device that can convert DC sources from one voltage level to another using a DC/DC converter. For example, the DC/DC converter, which may also be called a DC/DC power converter or a voltage regulator, may generally receive a first DC voltage as an input and output a second DC voltage, where the second (output) DC voltage can be higher or lower than the first (input) DC voltage. For example, the DC/DC converter may be coupled between two electrical systems that operate at different voltage levels, shown in FIG. 1 as a high voltage system (e.g., operating at 140 volts (V)) and a low voltage system (e.g., operating at 14 V). Accordingly, the DC/DC converter can convert the voltage between the high voltage system and the low voltage system, from high to low or from low to high. The conversion from one voltage level to another is typically done with some power losses, where the efficiency of the DC/DC converter can be 75% to 95% or higher, depending on the operating point of the DC/DC converter (e.g., voltage and current) and the type of converter.

There are two types of DC/DC converters: linear and switching. Linear DC/DC converters generally use a resistive voltage drop to create and regulate a given output voltage. One problem with using a linear DC/DC converter is that the output voltage is lower than the input voltage. If the input voltage is relatively higher than the output voltage, linear DC/DC converters are inefficient. Switching DC/DC converters work by storing the input energy temporarily and then releasing that energy to the output at a different voltage. The electrical energy can be stored in one or more magnetic field storage components (e.g., inductors and/or transformers) and/or in one or more electric field storage components (e.g., capacitors). The output voltage could be higher than or lower than the input voltage and switching DC/DC converters have a higher efficiency than linear DC/DC converters, especially when the input voltage is relatively higher than the output voltage.

Traditionally, switching DC/DC converters were controlled using analog techniques because analog techniques were simple to implement and digital components were too slow compared with analog components. However, in recent years, the introduction of high-speed, low-power consumption, and inexpensive integrated circuits has made digital DC/DC converters more feasible. Digital DC/DC converters offer various advantages, which include providing designers with the ability to implement closed-loop control with fewer components and/or enabling a control strategy to be easily adjusted in code using programmable logic devices (e.g., a digital signal processor (DSP), a field-programmable gate array (FPGA), and/or a microcontroller), among other examples.

However, one challenge that arises in a switching DC/DC converter is that a ripple is present in the output voltage or current. For a switching DC/DC converter that uses an inductor to store the energy, techniques to reduce the ripple may include increasing the switching frequency or increasing the inductance value of the inductor. Usually, the period of a control loop in a programmable logic device is equal to the switching period, whereby the clock frequency of the programmable logic device must be high enough to complete the calculation in the period of the control loop when the switching frequency is relatively high, which increases the cost of the programmable logic device. Furthermore, an inductor with a higher inductance value generally has a larger size and a higher cost. Accordingly, some implementations described herein relate to a DC/DC switching converter with a high switching frequency and a low control frequency, which results in a smaller ripple because the switching frequency is higher, and a lower cost because an inductor with a low inductance value and a programmable logic device with a low cost may be used. For example, some implementations described herein relate to a DC/DC converter that has a first frequency for switching a metal-oxide-semiconductor field-effect transistor (MOSFET) and a second frequency for a control loop.

In some implementations, the MOSFET switching frequency is high to reduce the ripple in the output current and increase efficiency of the MOSFET, and the control loop frequency is low such that sophisticated algorithms can be adopted and the cost of a control chip can be reduced. In this way, the digital switching DC/DC converter described herein may provide good output stability at high switching frequencies without requiring more expensive and/or larger inductors or more expensive and/or faster logic devices. For example, in some implementations, the DC/DC converter described herein may include a microcontroller that supports using a high-speed frequency for switching and a low-speed frequency for a control loop. In contrast, switching DC/DC converters conventionally use the same frequency (and therefore the same period) for switching and control, which creates a design trade-off where the single frequency must be fast enough to reduce ripple in one period, but slow enough to execute the necessary control algorithms in one period. By using separate switching and control loop frequencies in the DC/DC converter described herein, the faster switching frequency with a shorter period provides better switching speeds (e.g., reducing ripple without needing to use a larger inductor), while the slower control loop frequency provides longer periods for running complex control logic without needing a faster and/or more expensive logic chip.

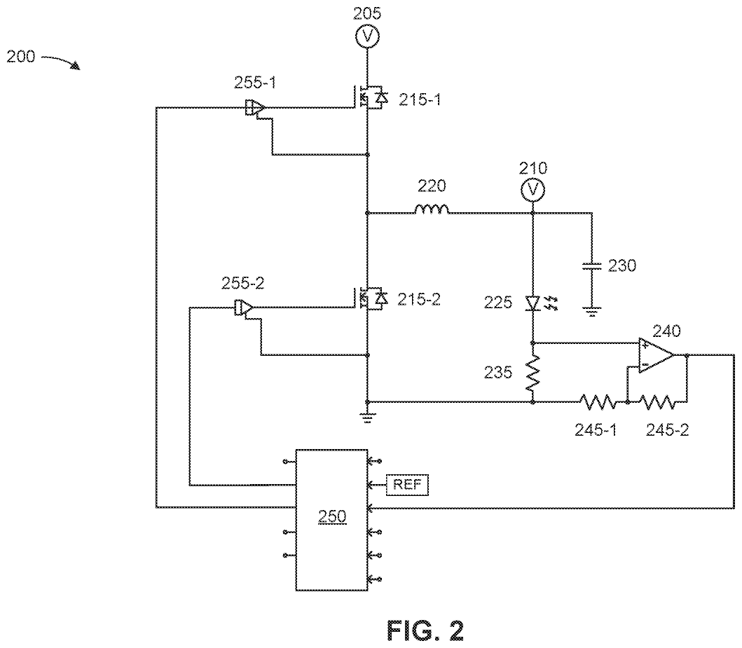

FIG. 2 is a diagram of an example high-frequency switching DC/DC converter 200 with different control loop and switching frequencies. In some implementations, as described herein, the switching DC/DC converter 200 may include a microcontroller 250 having multiple high-resolution timers, including a first high-resolution timer that may be used to generate a high-frequency signal to switch one or more MOSFETs (e.g., from an on state to an off state, or from an off state to an on state) and a low-frequency signal to trigger a control loop update. As shown in FIG. 2, in addition to the microcontroller 250, the switching DC/DC converter 200 may include an input voltage (Vin) 205, an output voltage 210, a high-side MOSFET 215-1 coupled to a high-side gate driver 255-1, a low-side MOSFET 215-2 coupled to a low-side gate driver 255-2, an energy storage device 220, a load 225, an output capacitor 230, and a feedback circuit that includes a feedback resistor 235, a voltage amplifier 240, and a pair of gain resistors 245-1, 245-2 that are used to set a gain of the voltage amplifier 240. In some implementations, as described herein, the load 225 may be associated with a high-power laser or another suitable device (e.g., the load 225 for the high-power laser could have a power over 100 watts (W), including up to 2400 W, such as 30 amps (A)×80 V). In some implementations (e.g., as shown in FIG. 2), the energy storage device 220 may include an inductor, although it will be appreciated that the energy storage device 220 may include any suitable magnetic field storage component (e.g., an inductor and/or a transformer), electric field storage components (e.g., a capacitor), and/or any suitable combination thereof.

In some implementations, as described herein, the high-frequency switching DC/DC converter 200 may operate by temporarily storing input energy in the energy storage device 220, which may be referred to herein as inductor 220, and then releasing the energy stored in the inductor 220 to the output (e.g., at a different voltage). For example, the high-side MOSFET 215-1 and the low-side MOSFET 215-2 may generally have opposite states, where the high-side MOSFET 215-1 is switched on (e.g., configured to operate in an on state) when the low-side MOSFET 215-2 is switched off (e.g., configured to operate in an off state) and vice versa. In general, the microcontroller 250 may be configured to switch the high-side MOSFET 215-1 and the low-side MOSFET 215-2 between the on and off states, for example, using respective pulse-width modulation (PWM) signals that are provided to the high-side gate driver 255-1 coupled to the high-side MOSFET 215-1 and the low-side gate driver 255-2 coupled to the low-side MOSFET 215-2. In some implementations, as described herein, the switching DC/DC converter 200 may operate at a high switching frequency, which may include frequencies at or higher than approximately 100 kilohertz (kHz) (e.g., some implementations described herein may support switching frequencies up to approximately 600 kHz).

In some implementations, in a first state, the high-side MOSFET 215-1 may be switched on and the low-side MOSFET 215-2 may be switched off. In the first state, the input voltage 205 (e.g., the power supply) may produce a current that flows through the high-side MOSFET 215-1 and the inductor 220 such that the current may drive the load 225. Accordingly, in the first state, the current that drives the load 225 may also charge the inductor 220, whereby the inductor 220 may store a large amount of energy. Furthermore, as shown, the feedback circuit that includes the feedback resistor 235, the voltage amplifier 240, and the gain resistors 245 may produce a feedback voltage based on the feedback current that is used to drive the load 225 (e.g., the feedback current is the average current of the first state and the second state because there is a low frequency filter on the current). For example, as shown, the feedback voltage that is output from the voltage amplifier 240 may be provided to the microcontroller 250 along with a reference voltage (shown as “REF” in FIG. 2), and the microcontroller 250 may be configured to adjust the duty cycle of the PWM signals to the high-side MOSFET 215-1 and the low-side MOSFET 215-2 based on the feedback voltage on the feedback resistor 235. For example, the microcontroller 250 may adjust the duty cycle of the PWM signals to increase a proportion of time that the high-side MOSFET 215-1 is switched on when the feedback voltage is below the reference voltage and/or may adjust the duty cycle of the PWM signals to increase a proportion of time that the low-side MOSFET 215-2 is switched on when the feedback voltage exceeds the reference voltage. In cases where the high-side MOSFET 215-1 is switched off and the low-side MOSFET 215-2 is switched on, there may be no current originating from the power supply (e.g., the input voltage 205), which may cause the energy stored in the inductor 220 to be discharged. At this time, when the inductor 220 discharges, the discharged energy may produce a current that flows through the load 225 and through the low-side MOSFET 215-2.

Accordingly, in some implementations, the high-side MOSFET 215-1 and the low-side MOSFET 215-2 may generally operate according to a duty cycle that refers to respective proportions of time that the high-side MOSFET 215-1 and the low-side MOSFET 215-2 spend in the on state. For example, in a use case where the high-side MOSFET 215-1 and the low-side MOSFET 215-2 operate with a duty cycle of 75%, the high-side MOSFET 215-1 would be switched on 75% of the time and the low-side MOSFET 215-2 would be switched on 25% of the time. However, in cases where the duty cycle is relatively high (e.g., there is a long period of time when the high-side MOSFET 215-1 is switched on and a relatively short period of time when the low-side MOSFET 215-2 is switched on), the charging time for the inductor 220 may be longer, which may result in the inductor 220 storing more energy and therefore producing a high current or a high voltage at the load 225. Accordingly, the microcontroller 250 may be configured to operate a control loop to control the duty cycle of the high-side MOSFET 215-1 and the low-side MOSFET 215-2 and thereby control the output voltage or output current at the load 225. For example, the microcontroller 250 may be configured to receive the reference voltage (e.g., based on a user-specified or user-provided value) and sample the feedback voltage provided at the output from the feedback circuit (e.g., at the output from the feedback resistor 235 and the voltage amplifier 240). In some implementations, in cases where the microcontroller 250 determines that the feedback voltage exceeds the reference voltage, the output current at the load 225 may be relatively high. Accordingly, the microcontroller 250 may reduce a target duty cycle for the high-side MOSFET 215-1 and the low-side MOSFET 215-2, where reducing the target duty cycle may include decreasing a proportion of time that the high-side MOSFET 215-1 is switched on and increasing a proportion of time that the low-side MOSFET 215-2 is switched on. Additionally, or alternatively, in cases where the feedback voltage is below the reference voltage, meaning that the output current at the load 225 is relatively low, the microcontroller 250 may increase the target duty cycle, which may increase the proportion of time that the high-side MOSFET 215-1 is switched on and decrease the proportion of time that the low-side MOSFET 215-2 is switched on.

Accordingly, as described herein, the feedback circuit (e.g., including the feedback resistor 235 and the voltage amplifier 240) may be configured to convert an output current that drives the load 225 into a feedback voltage. For example, the output current may be supplied by the input voltage 205 and may charge the inductor 220 when the high-side MOSFET 215-1 is switched on and the low-side MOSFET 215-2 is switched off, or the output current that drives the load 225 may be supplied by energy discharged by the inductor 220 when the high-side MOSFET 215-1 is switched off and the low-side MOSFET 215-2 is switched on. In either case, the feedback voltage and the reference voltage may be input to the microcontroller 250, which may output a high-side PWM signal that is provided to the high-side gate driver 255-1 to control a target state of the high-side MOSFET 215-1 and a low-side PWM signal that is provided to the low-side gate driver 255-2 to control a target state of the low-side MOSFET 215-2. In some implementations, a ripple in the output current could potentially be reduced by using multiple output capacitors 230 that have large capacitance values. However, in high-power laser applications or other applications where a rise time and a fall time of the output current must be very short (e.g., less than 20 microseconds (μs) for a current rising from 0 A to 20 A), the DC/DC converter 200 may not have any output capacitors with a large capacitance value. Accordingly, in order to achieve a small ripple on the output current that drives the load 225, a PWM signal with a high switching frequency may be used (e.g., rather than using an inductor 220 with a relatively high inductance value, which would increase the size and cost of the inductor 220 and therefore the size and cost of the DC/DC converter 200).

For example, in some implementations, the microcontroller 250 may include multiple high-resolution timers with at least two channels that can be used to simultaneously provide different high-precision high-resolution frequencies. Accordingly, a first (higher) frequency may be used for switching the MOSFETs 215 and a second (lower) frequency may be used for a control loop in which the feedback voltage is sampled and used to calculate a new target duty cycle for the MOSFETs 215. For example, the microcontroller 250 may calculate a new (target) duty cycle based on the feedback voltage in a current cycle and may update the duty cycle of a PWM signal in a next cycle based on the feedback voltage in the current cycle (e.g., the duty cycle of the PWM signal in each cycle is determined by the feedback voltage in the previous cycle). In this way, the MOSFETs 215 may be switched by PWM signals at the higher switching frequency, the control loop may operate at the lower control loop frequency, and the inductor 220 can have a low inductance value, which results in the output current that drives the load 225 having a small ripple and the switching DC/DC converter 200 having a relatively low cost. Furthermore, in some implementations, the high-resolution timer associated with the microcontroller 250 may be designed for analog-to-digital converters (ADCs) and fault inputs, which enables the switching DC/DC converter 200 to operate desired control loop and switching frequencies and provide the load 225 (e.g., the high-power laser load) with a continuous current, a short rise time, and a short fall time. For example, in a switching DC/DC converter with a single fixed frequency (e.g., only one timer), the single timer can only be used to control the switching frequency of the MOSFETs, which means that the control loop of the microcontroller is identical to the switching frequency of the MOSFETs (e.g., 100 or 300 kHz). In contrast, the microcontroller 250 used in the switching DC/DC converter 200 includes multiple channels, which allows the switching frequency of the MOSFETs 215 to be significantly higher than the control cycle of the microcontroller 250 (e.g., the microcontroller 250 may support a 600 kHz switching frequency and a control loop frequency of 300 kHz).

Accordingly, as shown in FIG. 2 and described in further detail herein, the switching DC/DC converter may comprise a first transistor (e.g., a high-side MOSFET) 215-1 arranged to receive an input voltage 205 and a second transistor (e.g., a low-side MOSFET) 215-2, where the second transistor 215-2 is in an off state when the first transistor is in an on state 215-1 and the second transistor 215-2 is in the on state when the first transistor 215-1 is in the off state. Furthermore, the switching DC/DC converter includes an energy storage device 220 configured to store energy when the first transistor 215-1 is in the on state and to discharge the stored energy when the second transistor 215-2 is in the on state, and a load 225 driven by an output current produced by the input voltage 205 when the first transistor 215-1 is in the on state and by the stored energy discharged from the energy storage device 220 when the second transistor 215-2 is in the on state. Furthermore, the switching DC/DC converter 200 may comprise a feedback circuit (e.g., a feedback resistor 235, a voltage amplifier 240, and one or more gain resistors 245) arranged to convert the output current into a feedback voltage and a microcontroller 250 configured to trigger a control loop to read the feedback voltage based on an interrupt having a periodicity that is based on a control loop frequency (e.g., 300 kHz). In some implementations, the microcontroller 250 may calculate a target duty cycle for the first transistor 215-1 and the second transistor 215-2 based on the feedback voltage, where the target duty cycle controls respective proportions of time that the first transistor 215-1 and the second transistor 215-2 spend in the on state. Accordingly, the microcontroller 250 may output, based on the target duty cycle, a first PWM signal to switch the first transistor 215-1 between the on state and the off state and a second PWM signal to switch the second transistor 215-2 between the on state and the off state. For example, as described herein, the first PWM signal and the second PWM signal are associated with a switching frequency that differs from (e.g., is higher than) the control loop frequency.

The number and arrangement of components shown in FIG. 2 are provided as an example. The switching DC/DC converter 200 may include additional components, fewer components, different components, or differently arranged components than those shown in FIG. 2. Additionally, or alternatively, a set of components (e.g., one or more components) of the switching DC/DC converter 200 may perform one or more functions described as being performed by another set of components of the switching DC/DC converter 200.

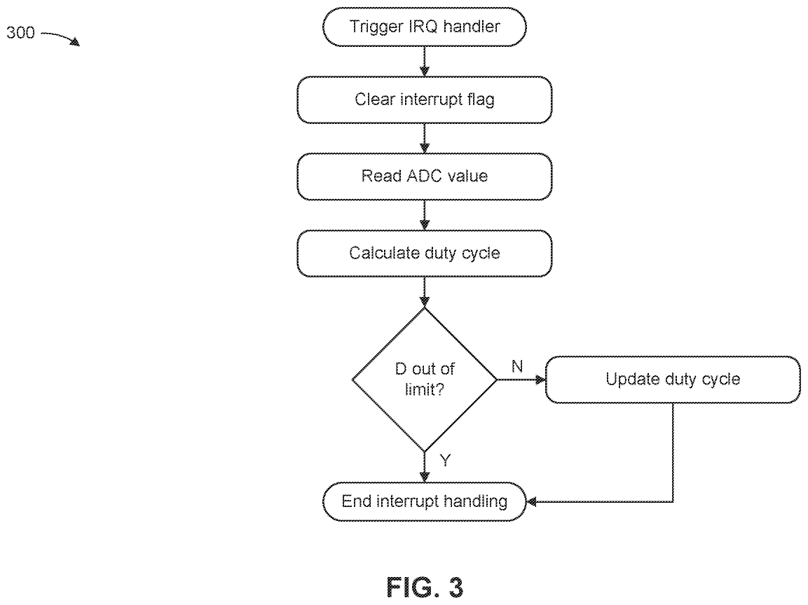

FIG. 3 is a flowchart of an example process 300 associated with operating a control loop in the high-frequency switching DC/DC converter described herein. In some implementations, process 300 may be performed by the microcontroller 250 shown in FIG. 2.

In some implementations, in a control loop for the switching DC/DC converter 200 described herein, a first ADC channel may be used for a reference voltage and a second ADC channel may be used for a feedback voltage. The microcontroller 250 may include a high-resolution timer that may be set for a PWM output, and a reset signal of the high resolution timer for the control loop may be set to trigger ADC sampling (e.g., by the microcontroller 250). In some implementations, as shown in FIG. 3, the process 300 for operating the control loop may include triggering an interrupt request (IRQ) handler when the ADC sampling is completed. For example, an interrupt may be triggered to initiate the process 300 for operating the control loop at a periodicity that is based on a fixed control loop frequency, such as every 3.3 μs for a control loop frequency of 300 kHz. As further shown in FIG. 3, after the interrupt triggers the control loop, an interrupt flag may be reset or otherwise cleared such that the process 300 will be triggered again in a next iteration (e.g., in another 3.3 μs). The microcontroller 250 may then read the ADC value, which refers to the feedback voltage output by the feedback circuit, and the microcontroller may calculate a target duty cycle value, D, for the PWM signals that are provided to the high-side and low-side gate drivers 255.

For example, in some implementations, the microcontroller 250 may be configured with a library that includes a control algorithm to calculate the target duty cycle value (e.g., the control algorithm may include a proportional integral derivative (PID) controller function, such as an arm_pid_f32 function in a PID controller library of an ARM processor). For example, the microcontroller may decrease the duty cycle (e.g., decreasing the proportion of time that the high-side MOSFET 215-1 is switched on and increasing the proportion of time that the low-side MOSFET 215-2 is switched on, thereby decreasing the charge time for the inductor 220, if the feedback voltage exceeds the reference voltage). Alternatively, the microcontroller may increase the duty cycle (e.g., increasing the proportion of time that the high-side MOSFET 215-1 is switched on and decreasing the proportion of time that the low-side MOSFET 215-2 is switched on, thereby increasing the charge time for the inductor 220, if the feedback voltage is below the reference voltage). In general, as described herein, the reference voltage may be based on a desired output current that is used to drive the load 225, where the reference voltage may be input to the microcontroller 250 via a user interface. In some implementations, the microcontroller may then update a register in the high-resolution timer with the target duty cycle, D, in cases where the new duty cycle is not out of a limit (e.g., is less than or equal to or otherwise satisfies a threshold). In this way, in a next PWM cycle, the microcontroller 250 may output a set of PWM signals that are based on the target duty cycle. Otherwise, in cases where the target duty cycle is out of the limit (e.g., exceeds or otherwise fails to satisfy the threshold), the interrupt handling function may end without updating the register in the high-resolution timer (e.g., the target duty cycle is not applied if the target duty cycle is outside a given range, in which case the duty cycle is maintained at the previous value).

In some implementations, the control process 300 may include additional aspects, such as any single aspect or any combination of aspects described above, below, and/or in connection with one or more other processes described elsewhere herein. Furthermore, although FIG. 3 shows example blocks of the control process 300, in some aspects, the control process 300 may include additional blocks, fewer blocks, different blocks, or differently arranged blocks than those depicted in FIG. 3. Additionally, or alternatively, two or more of the blocks of the control process 300 may be performed in parallel.

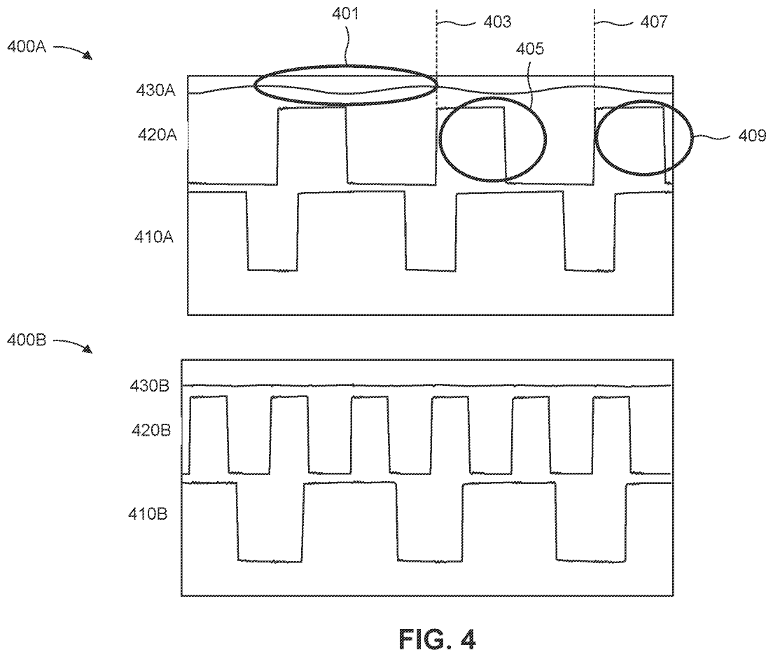

FIG. 4 is a diagram of example waveforms 400A in a DC/DC converter that uses a single control loop and switching frequency relative to example waveforms 400B in the high-frequency switching DC/DC converter described herein. As described herein, example waveforms 400A and example waveforms 400B may each be based on a configuration that includes one or more parameters for a microcontroller that samples a feedback voltage to calculate a target duty cycle that increases or decreases a proportion of time that an energy storage device is charged in order to regulate an output current that is either driven by an input voltage while the energy storage device is being charged or by the energy that is stored in the energy storage device while the output current is driven by the voltage source. Furthermore, as described elsewhere herein, the microcontroller may be configured to generate a pair of PWM signals (or switching signals) to control respective states for a pair of transistors. In FIG. 4, the example waveforms 400A and the example waveforms 400B may each be associated with a configuration in which the microcontroller is set to a maximum system clock frequency (e.g., 170 megahertz (MHz)), and a switching (PWM) frequency is set to a lower frequency (e.g., 300 kHz). In order to obtain a running time of a control loop (e.g., an IRQ handler function) that is periodically triggered to calculate a target duty cycle for the pair of MOSFETs, a test general purpose input/output (GPIO) pin may be set when the IRQ handler function associated with the control loop begins, and the test GPIO pin may be reset when the IRQ handler function ends.

Referring to FIG. 4, reference numbers 401, 403, 405, and 407 generally illustrate the control loop with reference to example waveforms 400A. However, it will be appreciated that the control loop may operate in a similar manner with respect to waveforms 400B, except that waveforms 400A depict an example where the switching and control loop frequencies are the same and waveforms 400B depict an example where the switching frequency is higher than the control loop frequency. As shown in FIG. 4, reference number 401 depicts a period of time during which the microcontroller samples the current at the load of the switching DC/DC converter, where the sampled current is the average current during this time period. As further shown in FIG. 4, reference number 403 depicts a time when the control loop is triggered, and reference number 405 depicts a time period associated with calculating the target duty cycle based on the current that was sampled during the period of time corresponding to reference number 401. As further shown in FIG. 4, reference number 407 depicts a time when the target duty cycle for the next cycle is triggered, and reference number 409 depicts the PWM signal with the target duty cycle for the next cycle applied.

Referring to FIG. 4, in example waveforms 400A, the bottom waveform 410A may be measured at the test GPIO pin and shows the running time and periodicity of the control loop, and the middle waveform 420A represents a high-side PWM switching signal based on a 300 kHz switching frequency. Furthermore, it will be appreciated that a low-side PWM switching signal based on the switching frequency may have a similar shape as the middle waveform 420A that represents the high-side PWM switching signal. In this case, as shown by waveforms 410A and 420A, the control loop and the switching signal operate at substantially the same frequency (e.g., the maximum switching frequency for the PWM switching signal should not exceed 450 kHz, and should remain below 400 kHz to allow some additional running time for the main function in the code used to implement the control loop). As further shown in FIG. 4, the top waveform 430A is the output current at the load in an example where the periodicity of the control loop is 3.3 μs (e.g., based on a 300 kHz frequency). However, the output current has a ripple with an amplitude of almost 200 milliamps (mA), which may result in poor performance. If a higher switching frequency is needed for the high-side and/or low-side PWM signals (e.g., 600 kHz) to decrease the output ripple, the techniques described herein to implement a control loop in which the feedback voltage is sampled and compared to a reference voltage to calculate the target duty cycle may not work up to the maximum PWM frequency because the total running time available in one period (e.g., about 1.7 μs, which is half of the periodicity of the control loop) would be too short to adequately sample the feedback voltage and calculate the optimal target duty cycle.

Accordingly, in FIG. 4, example waveforms 400B may be produced when the control techniques described herein are implemented, where a microcontroller uses different MOSFET switching and control frequencies. For example, in some implementations, the microcontroller may include multiple (e.g., ten) channels associated with a high-resolution timer, and the multiple channels can each be configured independently. As described elsewhere herein, one high-resolution timer may be configured as a PWM output channel (e.g., to switch MOSFETs between different states such that an output current is either driven by an input voltage while storing energy in an inductor, or by discharging the energy stored in the inductor). In example waveforms 400B, the high-resolution timer is configured as a channel with a 600 kHz frequency, which works as a PWM output to switch the high-side and low-side MOSFETs. Another high-resolution timer may be enabled to trigger the control loop with a lower frequency of 300 kHz. For example, in FIG. 4, the bottom waveform 410B is the measurement at the test GPIO pin, which shows a control frequency at 300 kHz, the middle waveform 420B is the PWM switching signal with a 600 kHz frequency, and the top waveform 430B is the output current, which is very stable despite the control frequency being half the PWM switching frequency. Furthermore, the ripple of the output current is about 100 mA, which is half the value of the ripple in waveform 430A (e.g., when the control loop and switching signals are at the same frequency).

As indicated above, FIG. 4 is provided as an example. Other examples may differ from what is described with regard to FIG. 4.

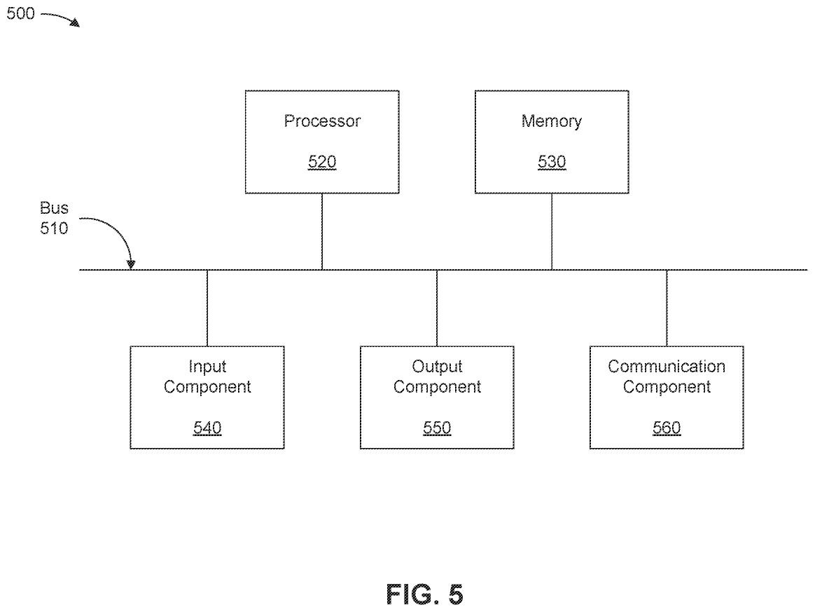

FIG. 5 is a diagram of example components of a device 500 associated with a high-frequency switching DC/DC converter with different control loop and switching frequencies. The device 500 may correspond to the microcontroller 250 shown in FIG. 2. In some implementations, the microcontroller 250 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

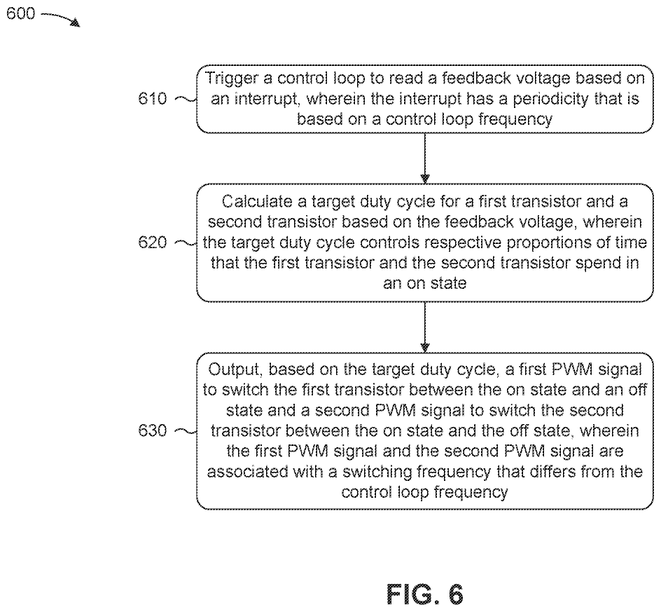

FIG. 6 is a flowchart of an example process 600 associated with controlling a high-frequency switching DC/DC converter with different control loop and switching frequencies. In some implementations, one or more process blocks of FIG. 6 are performed by a microcontroller (e.g., microcontroller 250). In some implementations, one or more process blocks of FIG. 6 are performed by another device or a group of devices separate from or including the microcontroller. Additionally, or alternatively, one or more process blocks of FIG. 6 may be performed by one or more components of device 500, such as processor 520 and/or memory 530.

As shown in FIG. 6, process 600 may include triggering a control loop to read a feedback voltage based on an interrupt, wherein the interrupt has a periodicity that is based on a control loop frequency (block 610). For example, the microcontroller may trigger a control loop to read a feedback voltage based on an interrupt, wherein the interrupt has a periodicity that is based on a control loop frequency, as described above.

As further shown in FIG. 6, process 600 may include calculating a target duty cycle for a first transistor and a second transistor based on the feedback voltage, wherein the target duty cycle controls respective proportions of time that the first transistor and the second transistor spend in an on state (block 620). For example, the microcontroller may calculate a target duty cycle for a first transistor and a second transistor based on the feedback voltage, wherein the target duty cycle controls respective proportions of time that the first transistor and the second transistor spend in an on state, as described above.

As further shown in FIG. 6, process 600 may include outputting, based on the target duty cycle, a first PWM signal to switch the first transistor between the on state and an off state and a second PWM signal to switch the second transistor between the on state and the off state, wherein the first PWM signal and the second PWM signal are associated with a switching frequency that differs from the control loop frequency (block 630). For example, the microcontroller may output, based on the target duty cycle, a first PWM signal to switch the first transistor between the on state and an off state and a second PWM signal to switch the second transistor between the on state and the off state, wherein the first PWM signal and the second PWM signal are associated with a switching frequency that differs from the control loop frequency, as described above. In some implementations, the first PWM signal and the second PWM signal are associated with a switching frequency that differs from the control loop frequency.

Process 600 may include additional implementations, such as any single implementation or any combination of implementations described below and/or in connection with one or more other processes described elsewhere herein.

In a first implementation, calculating the target duty cycle includes determining that the feedback voltage is below a reference voltage, and calculating, based on the feedback voltage being below the reference voltage, a value for the target duty cycle that increases a proportion of time that the first transistor spends in the on state relative to a current duty cycle.

In a second implementation, alone or in combination with the first implementation, the value for the target duty cycle is calculated to decrease a proportion of time that the second transistor spends in the on state relative to the current duty cycle based on the feedback voltage being below the reference voltage.

In a third implementation, alone or in combination with one or more of the first and second implementations, calculating the target duty cycle includes determining that the feedback voltage exceeds a reference voltage, and calculating, based on the feedback voltage exceeding the reference voltage, a value for the target duty cycle that decreases a proportion of time that the first transistor spends in the on state relative to a current duty cycle.

In a fourth implementation, alone or in combination with one or more of the first through third implementations, the value for the target duty cycle is calculated to increase a proportion of time that the second transistor spends in the on state relative to the current duty cycle based on the feedback voltage exceeding the reference voltage.

In a fifth implementation, alone or in combination with one or more of the first through fourth implementations, process 600 includes resetting the interrupt when the control loop is triggered.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A switching direct current/direct current (DC/DC) converter, comprising:
a first transistor arranged to receive an input voltage;
a second transistor, wherein the second transistor is in an off state when the first transistor is in an on state and the second transistor is in the on state when the first transistor is in the off state;
an energy storage device configured to store energy when the first transistor is in the on state and to discharge the stored energy when the second transistor is in the on state;
a load driven by an output current produced by the input voltage when the first transistor is in the on state and by the stored energy discharged from the energy storage device when the second transistor is in the on state;
a feedback circuit arranged to convert the output current into a feedback voltage; and
a microcontroller configured to:
trigger a control loop to read the feedback voltage based on an interrupt, wherein the interrupt has a periodicity that is based on a control loop frequency;
calculate a target duty cycle for the first transistor and the second transistor based on the feedback voltage, wherein the target duty cycle controls respective proportions of time that the first transistor and the second transistor spend in the on state; and
output, based on the target duty cycle, a first pulse-width modulation (PWM) signal to switch the first transistor between the on state and the off state and a second PWM signal to switch the second transistor between the on state and the off state,
wherein the first PWM signal and the second PWM signal are associated with a switching frequency that differs from the control loop frequency.

2. The switching DC/DC converter of claim 1, wherein the target duty cycle increases the proportion of time that the first transistor spends in the on state relative to a current duty cycle, based on the feedback voltage being below a reference voltage.

3. The switching DC/DC converter of claim 1, wherein the target duty cycle decreases the proportion of time that the first transistor spends in the on state relative to a current duty cycle, based on the feedback voltage exceeding a reference voltage.

4. The switching DC/DC converter of claim 1, wherein the first PWM signal is provided to a first gate driver coupled to the first transistor and the second PWM signal is provided to a second gate driver coupled to the second transistor.

5. The switching DC/DC converter of claim 1, wherein the microcontroller is further configured to reset the interrupt when the control loop is triggered.

6. The switching DC/DC converter of claim 1, wherein the switching frequency is higher than the control loop frequency.

7. The switching DC/DC converter of claim 1, wherein the load is a high power laser.

8. The switching DC/DC converter of claim 1, wherein the energy storage device includes a magnetic field component or an electric field component.

9. A method for operating a direct current/direct current (DC/DC) converter, comprising:
generating, based on an input voltage provided to a first transistor, an output current to drive a load when the first transistor is in an on state,
wherein a storage device stores energy when the first transistor is in the on state;
generating, based on the energy stored by the storage device, the output current to drive the load when a second transistor is in the on state,
wherein the second transistor is in an off state when the first transistor is in the on state and the second transistor is in the on state when the first transistor is in the off state;
triggering, by a microcontroller, a control loop to read a feedback voltage based on the output current based on an interrupt that has a periodicity based on a control loop frequency;
calculating, by the microcontroller, a target duty cycle for the first transistor and the second transistor based on the feedback voltage; and
output, by the microcontroller based on the target duty cycle, a first pulse-width modulation (PWM) signal to switch the first transistor between the on state and the off state and a second PWM signal to switch the second transistor between the on state and the off state,
wherein the first PWM signal and the second PWM signal are associated with a switching frequency that differs from the control loop frequency.

10. The method of claim 9, wherein calculating the target duty cycle includes:
determining that the feedback voltage is below a reference voltage; and
calculating, based on the feedback voltage being below the reference voltage, a value for the target duty cycle that increases a proportion of time that the first transistor spends in the on state relative to a current duty cycle.

11. The method of claim 9, wherein calculating the target duty cycle includes:
determining that the feedback voltage exceeds a reference voltage; and
calculating, based on the feedback voltage exceeding the reference voltage, a value for the target duty cycle that decreases a proportion of time that the first transistor spends in the on state relative to a current duty cycle.

12. The method of claim 9, wherein the first PWM signal is provided to a first gate driver coupled to the first transistor and the second PWM signal is provided to a second gate driver coupled to the second transistor.

13. The method of claim 9, wherein the switching frequency is higher than the control loop frequency.

14. The method of claim 9, wherein the storage device includes an inductor.

15. A method for controlling a direct current/direct current (DC/DC) converter, comprising:
triggering, by a microcontroller, a control loop to read a feedback voltage based on an interrupt, wherein the interrupt has a periodicity that is based on a control loop frequency;
calculating, by the microcontroller, a target duty cycle for a first transistor and a second transistor based on the feedback voltage, wherein the target duty cycle controls respective proportions of time that the first transistor and the second transistor spend in an on state; and
outputting, by the microcontroller and based on the target duty cycle, a first pulse-width modulation (PWM) signal to switch the first transistor between the on state and an off state and a second PWM signal to switch the second transistor between the on state and the off state,
wherein the first PWM signal and the second PWM signal are associated with a switching frequency that differs from the control loop frequency.

16. The method of claim 15, wherein calculating the target duty cycle includes:
determining that the feedback voltage is below a reference voltage; and
calculating, based on the feedback voltage being below the reference voltage, a value for the target duty cycle that increases a proportion of time that the first transistor spends in the on state relative to a current duty cycle.

17. The method of claim 16, wherein the value for the target duty cycle is calculated to decrease a proportion of time that the second transistor spends in the on state relative to the current duty cycle based on the feedback voltage being below the reference voltage.

18. The method of claim 15, wherein calculating the target duty cycle includes:
determining that the feedback voltage exceeds a reference voltage; and
calculating, based on the feedback voltage exceeding the reference voltage, a value for the target duty cycle that decreases a proportion of time that the first transistor spends in the on state relative to a current duty cycle.

19. The method of claim 18, wherein the value for the target duty cycle is calculated to increase a proportion of time that the second transistor spends in the on state relative to the current duty cycle based on the feedback voltage exceeding the reference voltage.

20. The method of claim 16, further comprising:
resetting the interrupt when the control loop is triggered.
